(19) United States
(12) Patent Application Publication
(10) Pub. No.: US 2018/0209182 A1
(43) Pub. Date: Jul. 26, 2018

(54) DOOR HANDLE ASSEMBLY FOR A MOTOR VEHICLE

(71) Applicant: Huf Huelsbeck & Fuerst GmbH & Co. KG, Velbert (DE)

(72) Inventors: Andreas Beck, Bochum (DE); Serdal Bitirim, Velbert (DE); Dirk Mueller, Essen (DE); Martin Witte, Ahaus (DE)

(21) Appl. No.: 15/744,662

(22) PCT Filed: Jul. 4, 2016
(86) PCT No.: PCT/EP2016/065645

§ 371 Date: Jan. 12, 2018

(30) Foreign Application Priority Data
Jul. 13, 2015 (DE) 10 2015 111 311.2
Oct. 29, 2015 (DE) 10 2015 118 523.7
Oct. 29, 2015 (DE) 10 2015 118 525.3
Dec. 18, 2015 (EP) 15201091.4

(51) Int. Cl. E05B 81/76; E05B 1/00; E05B 85/10

(52) U.S. Cl. CPC E05B 81/76; E05B 85/10; E05B 1/0015

(57) ABSTRACT

A vehicle door handle with a handle component is provided. The handle component includes a hollow body, and an inductive sensor device is arranged in a cavity in order to detect an actuation of the handle component. A support having a support fastening section and a self-supporting section connected to the latter are arranged in the cavity, wherein the support fastening section is secured to the vehicle door handle, and wherein the self-supporting section of the support extends in the interior of the cavity at a distance from the wall surfaces of the handle component such that the self-supporting section of the support is mechanically decoupled from the wall surfaces of the handle component. The inductive sensor device is held in the self-supporting section, wherein a metallic material is arranged in at least one section of those wall surfaces of the handle component which surround the self-supporting section.

The invention relates to a vehicle door handle assembly. In particular, the invention relates to an exterior door handle assembly with a stationary handle and a sensor unit for detecting an actuation of the handle.

As part of the overall door handle assembly, exterior door handles have handles that a user can grasp around or behind. It is thus possible for the user to exert force on the handle in order to open or close the door or to move the door through its pivoting range. Vehicle door handles are provided with coupling means that permit the vehicle door handle to be mounted on the vehicle door.

Vehicle door handles of this type are known and available in a variety of designs. The invention, however, relates to the subgroup of vehicle door handles with a so-called stationary handle. Whereas with movable handles, a handle part of the vehicle door handle assembly that is to be grasped under or behind by a user is pivoted or moved in translatory fashion through the exertion of force, with stationary door handles, the handle cannot be pivoted or moved in translatory fashion. In door handles with a stationary handle, the handle is largely stationary relative to the door. In door handles with stationary handles, since there is no mechanical movement path, no direct mechanical action chain from the door handle to a door lock is produced. Instead, the door lock is triggered electrically as a function of a detected actuation so that it is possible to reduce the amount of mechanical hardware and to achieve savings with regard to costs and weight of the door handle assembly.

Such stationary handles and vehicle door handle assemblies are usually used in combination with electrically triggered door locks. Such electrically triggered door locks are generally known by the term “e-latch.” Another example of such a door system is described in EP 0,584,499 A1.

The way in which vehicle door handle assemblies with stationary handles detect the actuation of the handle is embodied in various ways in the prior art. Switches or capacitive sensors can be used on or in the vehicle door handle. It is also possible to use inductive sensors and this is also done in the context of the present invention.

Inductive sensors for this purpose are available on the market and generally function by means of a resonant circuit, which produces eddy currents in adjacent electrically conductive materials. The amplitude of the resonant circuit changes as a function of the position and movement of the electrically conductive material relative to the resonant circuit. This amplitude change can be detected and recorded for actuation recognition. The market for inductive sensors of this kind is correspondingly large. For example, there are also known sensors that are particularly suitable for use in door handles because of their compact design and low weight, for example sensors of the LDC series made by the Texas Instruments Company.

The handle of a vehicle door handle of this generic type is embodied in at least some sections as a hollow body with a cavity. The cavity is delimited by the wall surfaces of the handle. An inductive sensor unit is positioned in the cavity in order to detect an actuation of the handle.

The object of the invention is to achieve a particularly lightweight, reliable and inexpensive-to-manufacture door handle assembly with a stationary handle.

This object is attained by means of a vehicle door handle assembly with the features of claim 1.

Like the generically described vehicle door handles, the novel door handle also has a handle that can be grasped around or from behind. The vehicle door handle has coupling means that include an attachment of the vehicle door handle to the door. The coupling means in this case can also be embodied directly on the handle. The handle is embodied as a hollow body in at least some sections. The hollow body with the handle is delimited all around by wall surfaces of the handle. An inductive sensor unit is positioned in the cavity in order to detect an actuation of the handle.

As described above, inductive sensor units are suitable for detecting movements, displacements, or rotations of electrically conductive objects in their vicinity. The important thing in this connection is that a relative movement occurs between the detecting sensor unit and the electrically conductive object, for example a metallic object. According to the invention, the detection is improved and facilitated in that a support is provided in the cavity inside the handle. This support has at least one support-fastening section and a floating section connected to this support-fastening section. The support-fastening section is affixed to the vehicle door handle. This means that the support-fastening section is affixed to any component of the overall vehicle door handle assembly, which also includes an attachment to the handle.

The floating section of the support, which is secured by the support-fastening section, extends in the cavity of the handle spaced apart from the wall surfaces. This means that the floating section of the support is mechanically decoupled from the surrounding wall surfaces of the cavity since it is in fact held and affixed by the support-fastening section, but is itself spaced apart from the wall surfaces. The floating section is thus held between the inner wall surfaces of the cavity so to speak. The floating section can, for example, be positioned so that it protrudes into the cavity starting from the support-fastening section; it can also bridge across a region of the cavity between a plurality of support-fastening sections.

The inductive sensor unit is secured in this floating section of the support. A metallic material is positioned in at least one section of the wall surfaces of the cavity that surrounds the floating section.

The sensor unit is thus secured to the floating section inside the cavity, spaced apart from the wall surfaces. In or on the spaced-apart wall surfaces or a section thereof, the metallic material can be detected by means of the sensor unit. Because of the mechanical decoupling of the floating section in the cavity, it is possible to detect a relative displacement of the metallic material in the surrounding wall surfaces. The displacement or deformation of the wall surfaces relative to the sensor unit can be detected in a particularly reliable and sensitive fashion since a mechanical decoupling is provided. This is achieved because the support-fastening section to which the floating section is secured is mounted in a region that is not deformed or moved at all when an actuation occurs or is only deformed or moved slightly. If the handle element of the door handle is actuated, for example by pushing or pulling the door handle, then the outer wall can move slightly relative to the section with the inductive sensor unit that is secured in floating fashion on the inside. The sensor unit detects the relative movement in a sensitive fashion.

The important thing is that the floating design of a section of the support and the floating support of the sensor unit achieve an improved decoupling between movements of the sensor unit and those of the surrounding walls. In order to achieve this, the fastening section of the support must, if possible, be mounted in a section of the handle or of the vehicle door handle assembly in general, which, when an actuation occurs, is influenced significantly less than the walls of the handle.

In a preferred embodiment of the invention, the handle is embodied as an elongated body, with the cavity extending along the greatest longitudinal span of the handle in a middle section inside the handle. The support-fastening section is affixed in an off-center fashion relative to the middle section in the direction of this longitudinal span.

In other words, in this exemplary embodiment, with an elongated handle, the floating section is supported in floating fashion in the middle section that is to be actuated, with the support-fastening section being affixed adjacent to the middle section or in an end region of the middle section. As a result, the sensor unit is suspended in the floating in the middle section that is to be actuated, but the suspension mount is affixed laterally thereto in an end section of the handle or at least laterally to the middle section. If the middle section is deformed by a user, for example by pulling on the door handle, then this deformation takes place in the region surrounding the sensor unit and thus in a detectable way. The location of the suspension mount, however, is hardly influenced at all by the actuation since it is provided at a position that is laterally offset from the actuation region.

It is advantageous if respective support-fastening sections are positioned at ends of the floating section of the support that are oriented away from each other.

In this embodiment, a plurality of support-fastening sections is provided, for example at two ends of a floating section that are oriented away from each other. Like a bridge with two lateral points, this support design can ensure the fastening while the middle part, the floating section, supports the sensor unit so that it is spaced apart from the surrounding walls and bridges across a section of the cavity.

In a modification of the invention, the support-fastening section for the attachment to the vehicle door handle is connected to the coupling means of the vehicle door handle. In this embodiment, the mounting points that serve to affix the overall door handle assembly to the vehicle are also used to affix the support. This therefore produces a particularly stable, low-deformation suspension and fastening of the support structure in the door handle.

It is particularly preferable if the support-fastening sections extend laterally at an angle or in a curved fashion from a floating section positioned between them and are affixed on the inside of the handle at points that are spaced apart from each other so that the floating section is clamped between these points in the cavity and is secured in a floating fashion. By means of the support structure, the space between the mounting points is once again bridged over in the same way as with a bridge structure and whereas the middle part is spaced apart from the surrounding walls and is largely mechanically decoupled from them, the mounting points ensure a secure and stable holding of the sensor unit in the clamped floating section. A curvature or angling can also contribute to a further decoupling of handle deformations from the position of the floating section.

It is preferable if a metallic material in the form of a metallic layer is provided on a section of the inside of the walls of the handle in the cavity.

The inside of the handle is particularly close to the sensor unit and as a result, when the walls of the handle are deformed, this can be detected in a particularly sensitive way. The metallic layer can be embodied in the form of paint, a foil coating, or some other metallic layer material.

It is particularly advantageous if the floating section has a trough-like structure into which the sensor unit can be inserted. In such a trough-like recess, the sensor unit—for example positioned on a board and connected to it—is accommodated in a particularly secure fashion and is locked in position. It is also particularly advantageous if the sensor unit is encased in a casting compound in the trough-like recess. This prevents the sensor unit from moving or wiggling in the recess.

In a modification of the invention, connecting support contours are provided on the inside of the handle, between the walls of the handle in the region of the cavity. These support contours or support structures provide mutual support to wall sections situated opposite each other. As a result of this, a force and deformation that have been exerted on one of the walls are transmitted to another wall through a transmission of force by the support contours. For example, based on the assumption of a two-shelled design of the handle, with one shell oriented toward the vehicle in the region of the side facing the body panel of the vehicle and with a covering shell on the visible side, then this embodiment with support contours means that a pulling actuation on the side of the handle facing the vehicle can also produce a deformation on the visible side of the handle. By means of the support structures, a pushing on the visible side of the handle imparts a deformation on the side of the handle facing the vehicle.

This can be advantageously used so that a metallic structure such as a metallic foil is provided on only one side of the inside of the handle. Depending on whether a pulling force is exerted from one side of the handle or a pushing force is exerted from the other side of the handle, the transmission of force by the support structures causes the metallic foil to move in any case. Since the sensor assembly is secured inside the handle in floating fashion between the walls, in one direction, the metallic structure moves away from the sensor assembly and in the other direction, it moves toward the sensor assembly. The use of the support structures therefore makes it possible to detect both a pushing force exerted on one side of the handle and a pulling force exerted on the other side of the handle with the provision of just one metallic element and one sensor assembly.

The invention will now be explained in greater detail based on the accompanying drawings.

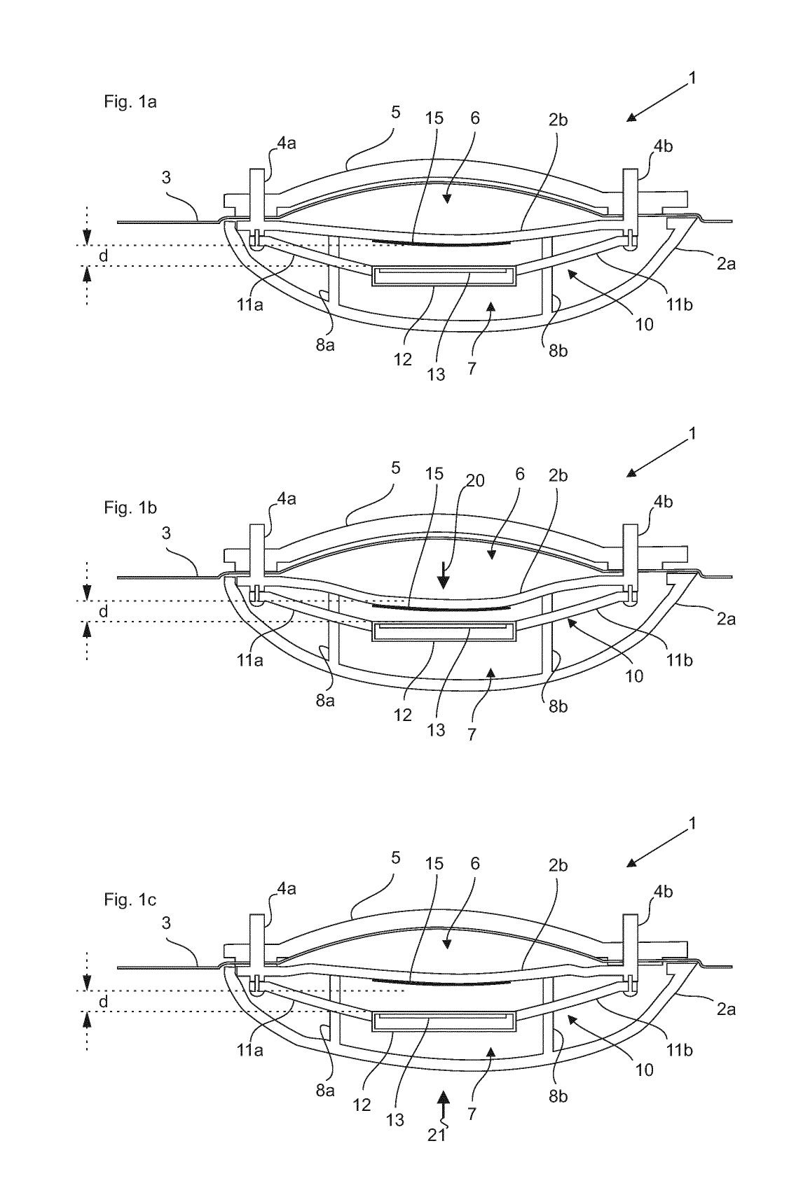

FIG. 1a shows an embodiment of the door handle assembly according to the invention in a rest position;

FIG. 1b shows the embodiment from FIG. 1a during a pulling actuation; and

FIG. 1c shows the embodiment from FIG. 1a during a pushing actuation.

FIG. 1a shows an embodiment of the door handle assembly 1. The door handle assembly has a handle, which is composed of two handle shells 2a, 2b. The two handle shells 2a, 2b form an enclosed elongated space. FIG. 1a shows a section extending parallel to the longitudinal axis of the handle. The handle is positioned on a door, on the outside of a door panel 3. Projections 4a, 4b, which constitute coupling means for affixing the door handle assembly to the vehicle, protrude through the door panel 3. On the inside of the door panel 3 (shown at the top in FIG. 1a), an internal support 5 for the door handle assembly is installed, which is engaged by the fastening means 4a and 4b, for example by means of a screw connection or detent engagement means.

Between the door panel 3 and the outwardly curved shell 2b of the handle, a grasping space 6 is provided. The hand of a user can be inserted into this grasping space and can exert a pulling force on the inside of the handle. A cavity 7 is formed on the inside of the shells 2a, 2b of the handle. Extending through the cavity 7, there are support structures 8a, 8b, which in this exemplary embodiment, are embodied as integrally joined to the shell 2a. The support structures 8a and 8b extend through the cavity 7 to the opposite inside of the shell 2b and are supported there. In this way, through the transmission of force by the support structures 8a and 8b, a deformation of one of the shells 2a or 2b in the middle section is transmitted to the respective other shell.

A support 10 also extends in the longitudinal direction through the cavity 7. The support 10 has support-fastening sections 11a, 11b at both ends. These support-fastening sections are attached to the fastening means 4a and 4b. Between the support-fastening sections 11a, 11b, a floating section 12 is embodied in the form of a trough in which the sensor assembly 13 is accommodated. The floating section 12 is secured in bridge fashion between the support-fastening sections 11a and 11b and is positioned spaced apart and decoupled from the middle region of the shells 2a and 2b.

The sensor assembly 13 in the floating section 12 therefore lies along the longitudinal axis of the handle assembly, approximately in the middle, mechanically decoupled from the shells 2a and 2b. On the shell 2b, in the region that corresponds to the middle section, a metal foil 15 is glued to the inside of the shell 2b. The metal foil 15 is correspondingly situated opposite from the sensor assembly 13, but is separated from it by an air gap. The inductive sensors of the sensor assembly 13 detect the distance of the metal foil 15. A change in the position of the metal foil 15 relative to the sensor assembly 13 results in a signal change. In addition, the sensor assembly 13 is connected to supply lines and signal lines, but they are not shown here for the sake of clarity.

In the rest position in FIG. 1, the distance between the metal foil 15 and the sensor assembly 13 is indicated by the distance d in FIG. 1a. This distance defines a rest position and the inductive sensors send a corresponding rest signal to the sensor assembly 13.

FIG. 1b shows an actuation of the door handle assembly. To accomplish this, a user reaches into the intermediate space 6 and by exerting a pulling force (indicated by the arrow 20), deforms the shell 2b in the region in which the metal foil 15 is mounted. The deformation is depicted in exaggerated fashion here in order to clearly show the function. Since the sensor unit 13 in the floating support section 12 is to a large extent mechanically decoupled from the shell 2b, the sensor assembly does not move along with it, but the metal foil 15 comes closer to the sensor assembly 13. This is apparent because the rest position distance d is once again shown with dashed lines in FIG. 1b, making it clear that this rest position distance has been exceeded. Correspondingly, the inductive sensors detect the approach of the metal foil 15 to the sensor assembly 13. The deformation of the handle shell 2b has hardly any effect on the position of the support 10 since the latter is affixed offset from the middle section and in fact in this exemplary embodiment, to the fastening means 4a, 4b that fasten the entire handle to the door panel 3.

FIG. 1c shows the case of an actuation in which a pushing force is exerted on the handle from the outside. This can occur, for example, in order to confirm that the user wishes to close the door. The rest position distance d is once again depicted with dashed lines in FIG. 1c.

The action of the support structures 8a and 8b is particularly apparent in this example. The pushing on the outer surface first deforms the shell 2a. By means of the support structures 8a and 8b, force is introduced into the shell 2b since the support structures 8a and 8b rest on this shell. As a result, the shell 2b is deformed in the direction of the arrow 21 and the metal foil 15 moves away from the sensor assembly 13. Once again, the deformation does not affect the support 10 since the latter, together with its floating section 12, is mechanically decoupled from the deformed regions. The support is in particular also entirely decoupled from the support structures 8a and 8b; the latter can extend past the support 10 or can extend through openings in the support, without mechanical contact.

This embodiment makes it possible by means of a single sensor assembly 13 to detect both the pulling of the door handle according to FIG. 1b and a pushing on the door handle according to FIG. 1c. In reality, the deformations are much smaller than the deformations shown in FIGS. 1b and 1c, but they have been depicted in exaggerated fashion in order to illustrate the invention.

In modifications of the invention, instead of a metal foil, it is also possible for the metallic element to be provided in the form of a chrome plating of the door handle. Alternatively, the material of the handle shells can also be equipped with metallic particles or regions in order to influence the inductive sensors of the sensor assembly 13.

1. A vehicle door handle for placement on a vehicle door; the vehicle door handle has a handle, which a user can grasp behind and the vehicle door handle has coupling means for attaching the vehicle door handle to the door; the handle is embodied in at least some sections as a hollow body with a cavity; the cavity is delimited by the wall surfaces of the handle; at least one inductive sensor unit is positioned in the cavity in order to detect an actuation of the handle,
characterized in that
a support is provided in the cavity the support has at least one support-fastening section and a floating section connected thereto; the at least one support-fastening section is affixed to the vehicle door handle; and the floating section of the support extends inside the cavity spaced apart from the wall surfaces of the handle so that the floating section of the support is mechanically decoupled form the wall surfaces of the handle;
the inductive sensor unit is secured in the floating section of the support; and
in at least one section of the wall surfaces of the handle, which surround the floating section, a metallic material is provided.

2. The vehicle door handle according to claim 1, wherein the handle is embodied as an elongated body and the cavity extends along the greatest longitudinal span in a middle section on the inside of the handle and the support-fastening section is affixed in an off-center fashion relative to the middle section in the direction of this longitudinal span.

3. The vehicle door handle according to claim 1, wherein respective support-fastening sections are provided at ends of the floating section of the support that are oriented away from each other.

4. The vehicle door handle according to claim 3, wherein the support-fastening section for the attachment to the vehicle door handle is connected to the coupling means of the vehicle door handle.

5. The vehicle door handle according to claim 3, wherein the support-fastening sections extend laterally at an angle or in a curved fashion from the floating section positioned between them and are affixed on the inside of the handle at points that are spaced apart from each other so that the floating section is clamped between these points in the cavity and is secured in a floating fashion.

6. The vehicle door handle according to claim 1, wherein a metallic material in the form of a metallic layer is provided on a section of the inside of the handle in the cavity.

7. The vehicle door handle according to claim 6, wherein the metallic layer is a metal foil.

8. The vehicle door handle according to claim 1, wherein the floating section of the support has a trough-like recess in which the inductive sensor unit is accommodated.

9. The vehicle door handle according to claim 8, wherein the inductive sensor unit is encased in a casting compound in the trough-like recess.

10. The vehicle door handle according to claim 1, wherein connecting support contours are provided between the walls of the handle in the region of the cavity and these support contours support opposing regions of the handle relative to each other so that through a transmission of force, a deformation of one of the handle is transmitted by the support contours to an opposing region of the handle.
